(19) United States
(12) Patent Application Publication
(10) Pub. No.: US 2026/0199843 A1
(43) Pub. Date: Jul. 16, 2026

(54) ZEOLITE-LIKE MOLECULAR SIEVE MEMBRANE FOR REMOVING FLUORINE AND CHLORINE FROM WASTE ACID AND PREPARATION METHOD THEREOF

(71) Applicants: Kunming Metallurgical Research Institute Co., Ltd., Yunnan (CN); Yunnan Xingxian Environmental Protection Technology Co., Ltd., Yunnan (CN)

(72) Inventors: Chongjun BAO, Yunnan (CN); Zhonghua ZHOU, Yunnan (CN); Weiguang FENG, Yunnan (CN); Zongqing SHEN, Yunnan (CN); Xin CHEN, Yunnan (CN); Weiwei LIU, Yunnan (CN); Youcheng YUE, Yunnan (CN); Wei ZOU, Yunnan (CN); Yanhua SUN, Yunnan (CN); Junxue YU, Yunnan (CN); Daxin HUANG, Yunnan (CN); Ran YANG, Yunnan (CN); Yuzhang LI, Yunnan (CN); Xiao WU, Yunnan (CN); Xinwei WEN, Yunnan (CN); Qiuyue YANG, Yunnan (CN)

(21) Appl. No.: 19/556,589

(22) Filed: Mar. 4, 2026

Related U.S. Application Data
(63) Continuation-in-part of application No. PCT/CN2025/142506, filed on Dec. 15, 2025.

(30) Foreign Application Priority Data
Jan. 14, 2025 (CN) 202510057982.6

(51) Int. Cl. B01D 67/00; B01D 69/14; B01D 71/02; B01D 71/34

(52) U.S. Cl. CPC B01D 67/00793; B01D 67/0088; B01D 69/14111; B01D 69/148; B01D 71/028; B01D 71/34; B01D 2323/081; B01D 2323/12; B01D 2323/219; B01D 2323/56

(57) ABSTRACT

Provided are a zeolite-like molecular sieve membrane for removing fluorine and chlorine from waste acid and a preparation method thereof. The molecular sieve membrane includes a dispersed phase and a continuous phase, where the dispersed phase is zeolite-like molecular sieve nanoparticles, and the continuous phase is prepared by dissolving and then polymerizing PVDF (polyvinylidene fluoride) monomer particles. The zeolite-like molecular sieve nanoparticles are prepared by dissolving a metal compound in a first solvent under an ultrasonic environment, and then dissolving in a second solvent to obtain a mixed solution I, and drying. The preparation method includes steps of preparing a PVDF molecular sieve blend membrane by blending and surface coating modification of the PVDF molecular sieve blend membrane.

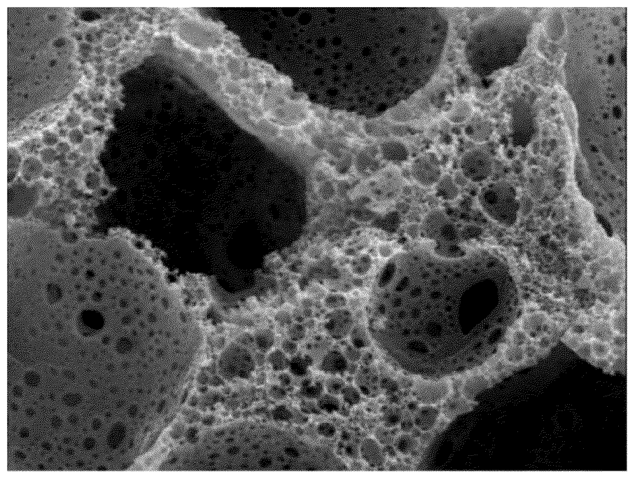

### CROSS REFERENCE TO RELATED APPLICATION

This patent application is a continuation-in-part of International Patent Application No. PCT/CN2025/142506, filed on Dec. 15, 2025, which claims the benefit and priority of Chinese Patent Application No. 202510057982.6 filed with the China National Intellectual Property Administration on Jan. 14, 2025, entitled “ZEOLITE-LIKE MOLECULAR SIEVE MEMBRANE FOR REMOVING FLUORINE AND CHLORINE FROM WASTE ACID AND PREPARATION METHOD THEREOF”. The disclosures of the two applications each are incorporated herein by reference in its entirety.

### TECHNICAL FIELD

This application belongs to the technical field of waste acid treatment, and in particular relates to a zeolite-like molecular sieve membrane for removing fluorine and chlorine from a waste acid and a preparation method thereof, exhibiting high removal rates of fluorine and chlorine, a high sulfate retention rate, good corrosion resistance, and a high permeate flux.

### BACKGROUND

Waste acid produced from metal smelting and smelting flue gas contains sulfuric acid as a main component. If sulfuric acid in the waste acid could be recycled during production, it would not only reduce production costs but also decrease the discharge of contaminants. However, due to the high concentration of fluorine and chloride ions in the waste acid, the equipment, devices, and pipeline valves are subject to high corrosion resistance requirements. Therefore, fluorine- and chlorine-containing waste acid must undergo the removal of fluorine and chloride ions before sulfate ions can be recycled.

Currently, the main methods for removing fluorine and chloride ions from waste acid include: physical removal, i.e., methods by hot air blow-off and nanofiltration/PVDF (polyvinylidene fluoride) flat sheet ultrafiltration membrane filtration, whereas hot air blow-off has low efficiency and high heat consumption, and membrane filtration suffers from the problem of a high retention rate of fluorine ions; chemical precipitation, i.e., methods of precipitating fluorine and chloride impurities by adding a bismuth salt, a calcium salt, or a rare earth removal agent, where there are problems of introducing new impurity elements, high costs, and failure in utilization of fluorine and chloride resources.

In the prior art, there are methods of adding a neutralizing agent, such as calcium carbonate, calcium oxide, and calcium hydroxide, to fluorine-chlorine waste acid to neutralize the waste acid; adding anionic polyacrylamide as a flocculant to promote the precipitation of calcium fluoride and calcium chloride; and then preparing calcium fluoride and calcium chloride, achieving the removal of fluorine and chloride ions from waste acid (e.g., CN111634934A), but also neutralize sulfuric acid in waste acid, thereby failing to achieve the recycling of sulfuric acid resources.

In this regard, other methods employ lanthanum chloride as a defluorinating agent and sodium sulfate as a lanthanum removing agent, which effectively remove fluorine ions from waste acid without introducing other impurity ions; lanthanum fluoride and sodium lanthanum sulfate obtained from the processes of defluorination and lanthanum removal can obtain lanthanum chloride through the processes of alkaline leaching for modification and acid leaching for regeneration, achieving the regeneration and recycling of the defluorinating agent; sodium sulfate obtained from alkaline leaching can also be recycled as a lanthanum removing agent; furthermore, silver sulfate is selected as a chlorine removing agent, which can prepare a high-value silver nanopowder after removing chloride ions from waste acid, achieving high-value recovery of the chlorine removing agent (e.g., CN114890526B). However, because such method introduces a defluorinating agent and a chlorine removing agent, such that the processes of alkaline leaching for modification and acid leaching for regeneration are lengthy and complex, which is unsuitable for treating a large amount of acid wastewater.

In view of the shortcomings of removing fluorine and chlorine from waste acid in the prior art, the inventors propose a concept: whether the molecular sieve membrane separation technology can be used to treat fluorine- and chlorine-containing waste acid. However, because waste acid is a complex, multi-component acidic liquid having high corrosiveness, conventional molecular sieve membranes are unsuitable for fluorine- and chlorine-containing waste acid systems. For example, a silicon-aluminum compound molecular sieve membrane, whose silicon aluminum skeleton is easily destroyed by fluorine- and chlorine-containing waste acid and substantially loses the molecular sieve function, is a disposable chemical precipitation consumable that cannot be regenerated or recycled, resulting in not only high costs, but also a fluorine removal rate far below the expected values, even the introduction of new silicon and aluminum impurities into the waste acid and severe interference with the determination of fluorine.

Therefore, the study of a molecular sieve membrane capable of improving the removal rates of fluorine and chloride ions from waste acid and reducing the loss rate of sulfate ions not only has important practical relevance, but also provides a new thought path for the removal of fluorine and chloride ions from various waste acids.

### SUMMARY

To address the shortcomings in the prior art, the present disclosure provides a zeolite-like molecular sieve membrane for removing fluorine and chlorine from a waste acid, exhibiting high removal rates of fluorine and chlorine, a high sulfate retention rate, good corrosion resistance, and a high permeate flux, and further provides a method for preparing the zeolite-like molecular sieve membrane for removing the fluorine and the chlorine from the waste acid.

In the present disclosure, the zeolite-like molecular sieve membrane for removing the fluorine and the chlorine from the waste acid is achieved by: the zeolite-like molecular sieve membrane including a dispersed phase and a continuous phase, where the dispersed phase is zeolite-like molecular sieve nanoparticles, and the continuous phase is formed by dissolving PVDF monomer particles; the zeolite-like molecular sieve nanoparticles are prepared by, under an ultrasonic environment, dissolving a metal compound in a first solvent, then dissolving in a second solvent to obtain a mixed solution I, and drying the mixed solution I.

The principle of preparation of zeolite-like molecular sieve nanoparticles: a specific metal compound is reacted with a specific solvent to obtain porous zeolite-like molecular sieve nanoparticles with a metal ion as a center and an organic matter as a ligand.

In some embodiments, the metal compound is selected from the group consisting of ZrCl₄ and Zr(OH)₄, the first solvent is selected from the group consisting of trimesic acid and biphenyl-4,4′-dicarboxylic acid, and the second solvent is a solution of one or any combination of ethanol, isopentyldiol and isohexanediol in deionized water.

In some embodiments, the metal compound is any one selected from the group consisting of ZnSO₄, ZnCl₂, CoCl₂, Co(NO₃)₂, CuSO₄, and Cu(NO₃)₂, the first solvent is one or any combination selected from the group consisting of imidazole, dimethylimidazole, and 2-methylimidazole, and the second solvent is a solution of one or any combination of ethanol, isopentyldiol, and isohexanediol in deionized water.

In some embodiments, the metal compound is selected from the group consisting of ZrCl₄, Zr(OH)₄, and Cr₂(SO₄)₃, the first solvent is succinic acid, and the second solvent is a solution of one or any combination of ethanol, isopentyldiol, and isohexanediol in deionized water.

In some embodiments, a mass percentage of the metal compound in the mixed solution is in a range of 2 wt % to 20 wt %.

In some embodiments, the zeolite-like molecular sieve nanoparticles have a cage-like spatial structure, and voids formed between cages become channels for ions passing through and having a pore size of 1 nm to 6 nm.

In the present disclosure, the method for preparing the zeolite-like molecular sieve membrane for removing the fluorine and the chlorine from the waste acid is achieved by: the method including steps of preparing the PVDF molecular sieve blend membrane by blending and surface coating modifying the PVDF molecular sieve blend membrane, specifically: A. preparing the PVDF molecular sieve blend membrane by blending: dissolving PVDF monomer particles in an organic solvent DMF (N,N-dimethylformamide) with a concentration of 8 wt % to 12 wt %, adding the zeolite-like molecular sieve nanoparticles as described in the above technical solutions, and then adding monomer polymerization initiators 4-vinylbenzyl chloride (VBC) and benzoyl peroxide (BPO), to obtain a mixed solvent II; reacting the mixed solvent II at a temperature of 60° C. to 70° C. for 7 hours to 9 hours under nitrogen protection to obtain a casting solution; vacuum degassing the casting solution and standing for 7 hours to 9 hours; then injecting a resulting stood casting solution into a casting template and scraping into a scraped membrane with a scraper; and removing the organic solvent by evaporating the scraped membrane; and immersing a resulting evaporated scraped membrane in a deionized water coagulation bath and curing to obtain the PVDF molecular sieve blend membrane; and B. surface coating modifying the PVDF molecular sieve blend membrane: immersing the PVDF molecular sieve blend membrane in ethanol and deionized water in sequence each for 20 minutes to 40 minutes, and then immersing in a dopamine hydrochloride buffer solution with stirring under an ultrasonic environment for 16 hours to 24 hours to obtain the zeolite-like molecular sieve membrane for removing the fluorine and the chlorine from the waste acid.

In some embodiments, in step A, in the mixed solvent II, a mass percentage of the PVDF monomer particles is in a range of 6 wt % to 12 wt %, a mass percentage of the zeolite-like molecular sieve nanoparticles is in a range of 0.5 wt % to 2 wt %, a mass percentage of the VBC is 2 wt %, and a mass percentage of the BPO is 0.02 wt %.

In some embodiments, in step B, the dopamine hydrochloride buffer solution is prepared by a process consisting of: preparing tris(hydroxymethyl)aminomethane and hydrochloric acid into a buffer solution having a pH value of 8.5, and dissolving dopamine (DA) and polyethyleneimine (PEI) in the buffer solution to obtain the dopamine hydrochloride buffer solution.

In some embodiments, a mass percentage of the DA in the dopamine hydrochloride buffer solution is in a range of 0.2 wt % to 1.6 wt %.

The principle of preparation of the PVDF molecular sieve blend membrane is to blend a polymer with zeolite-like molecular sieve nanoparticles to form a membrane; the polymer forms a continuous phase, and the zeolite-like molecular sieve nanoparticles form a dispersed phase; all the zeolite-like molecular sieve nanoparticles constitute a zeolite-like molecular sieve, thus solving the problem of poor compatibility between conventional molecular sieves and organic polymer matrice, and avoiding the formation of clusters and interfacial voids on the membrane surface from affecting separation; furthermore, the spatial structure of the zeolite-like molecular sieve nanoparticles is mostly cage-like, and different voids can be formed between the molecular cages; the voids become channels allowing ions to pass through and provide an effect of selective sieving. In the formed blend membrane, the polymer is the continuous phase, having an effective pore size equivalent to that of conventional nanofiltration membranes; the voids between the molecular cages in the dispersed phase are less than 6 nm (preferably 1 nm to 6 nm) to allow fluorine and chloride ions to pass through.

The principle of surface coating modification of PVDF molecular sieve blend membrane: a PVDF material is corrosion resistant, but the presence of C—F bonds renders the PVDF material highly hydrophobic, and thus causes easy contamination of the membrane material and affects the flux; although the hydrophobicity of the PVDF molecular sieve blend membrane has been reduced to a certain extent, for the continuous phase PVDF, the permeate flux is still low; therefore, modification is required to improve the hydrophilicity of the continuous phase.

Some embodiments of the present disclosure exhibit the following beneficial effects:

1. In the present disclosure, zeolite-like molecular sieve nanoparticles are prepared under an ultrasonic environment, making the newly prepared zeolite-like molecular sieve nanoparticles suitable for highly corrosive fluorine- and chlorine-containing waste acid systems. Furthermore, the method cleverly blends the zeolite-like molecular sieve nanoparticles with a polymer to form a membrane, and then performs surface coating modification of hydrophilicity, to prepare a zeolite-like molecular sieve membrane for waste acid systems. The zeolite-like molecular sieve membrane allows fluorine and chloride ions in the waste acid to permeate while retaining sulfate ions, thereby achieving highly efficient removal of fluorine and chloride ions from waste acid without introducing new impurities or with no need of consuming heat, also significantly reducing the loss rate of sulfate ions, and enabling the recycling of sulfuric acid resources.

2. Compared with conventional nanofiltration membranes and PVDF flat sheet ultrafiltration membranes, the zeolite-like molecular sieve membrane not only effectively removes fluorine and chloride from waste acid but also reduces the loss rate of sulfate ions, enabling the recycling of sulfuric acid resources and providing a new process approach for the removal of fluorine and chloride ions from various types of wastewater.

3. In the method for preparing a zeolite-like molecular sieve membrane, the PVDF molecular sieve blend membrane is hydrophilically modified by pre-preparing a dopamine hydrochloride buffer solution, which renders the PVDF molecular sieve blend membrane corrosion-resistant and also effectively reduces the hydrophobicity, thereby increasing the permeate flux when filtering waste acid.

In summary, the PVDF molecular sieve blend membrane exhibits high removal rates of fluorine and chlorine, a high sulfate retention rate, good corrosion resistance, and a high permeate flux.

### BRIEF DESCRIPTION OF THE DRAWING

FIGURE shows a magnified view of part of the zeolite-like molecular sieve membrane prepared in Example 1 of the present disclosure.

### DETAILED DESCRIPTION OF THE EMBODIMENTS

To make the object, technical solutions, and advantages of the present disclosure clearer, the following further describes the present disclosure in detail with reference to the accompanying drawing and the embodiments. It should be understood that the specific embodiments described herein are merely used to explain the present disclosure, but are not intended to limit the present disclosure.

In the present disclosure, the zeolite-like molecular sieve membrane for removing fluorine and chlorine from waste acid includes a dispersed phase and a continuous phase, where the dispersed phase is zeolite-like molecular sieve nanoparticles, and the continuous phase is formed by dissolving PVDF monomer particles; the zeolite-like molecular sieve nanoparticles are, under an ultrasonic environment, prepared by dissolving a metal compound in a first solvent, then dissolving in a second solvent to obtain a mixed solution I, and drying the mixed solution I.

In some embodiments, the metal compound is selected from the group consisting of ZrCl₄ and Zr(OH)₄, the first solvent is selected from the group consisting of trimesic acid and biphenyl-4,4′-dicarboxylic acid, and the second solvent is a solution of one or any combination of ethanol, isopentyldiol, and isohexanediol in deionized water.

In some embodiments, the metal compound is any one selected from the group consisting of ZnSO₄, ZnCl₂, CoCl₂, Co(NO₃)₂, CuSO₄, and Cu(NO₃)₂, the first solvent is one or any combination selected from the group consisting of imidazole, dimethylimidazole, and 2-methylimidazole, and the second solvent is a solution of one or any combination of ethanol, isopentyldiol, and isohexanediol in deionized water.

In some embodiments, the metal compound is selected from the group consisting of ZrCl₄, Zr(OH)₄, and Cr₂(SO₄)₃, the first solvent is succinic acid, and the second solvent is a solution of one or any combination of ethanol, isopentyldiol, and isohexanediol in deionized water.

In some embodiments, a mass percentage of the metal compound in the mixed solution is in a range of 2 wt % to 20 wt %.

In some embodiments, the zeolite-like molecular sieve nanoparticles have a cage-like spatial structure, and voids formed between molecular cages become channels for ions passing through and having a pore size of 1 nm to 6 nm.

In some embodiments, the mixed solution I is used to prepare zeolite-like molecular sieve nanoparticles by conventional low-temperature drying.

In some embodiments, a method for preparing the zeolite-like molecular sieve membrane for removing the fluorine and the chlorine from the waste acid includes steps of preparing the PVDF molecular sieve blend membrane by blending and surface coating modifying the PVDF molecular sieve blend membrane, specifically:
A. preparing the PVDF molecular sieve blend membrane by blending: dissolving PVDF (polyvinylidene fluorine) monomer particles in an organic solvent of DMF (N,N-dimethylformamide) with a concentration of 8 wt % to 12 wt %, and then adding the zeolite-like molecular sieve nanoparticles as described in the above technical solutions, and adding monomer polymerization initiators VBC (4-vinylbenzyl chloride) and BPO (benzoyl peroxide), to obtain a mixed solvent II; reacting the mixed solvent II at a temperature of 60° C. to 70° C. for 7 hours to 9 hours under nitrogen protection to obtain a casting solution; vacuum degassing the casting solution and standing for 7 hours to 9 hours; and then injecting the casting solution into a casting template and scraping into a scraped membrane with a scraper; removing the organic solvent by evaporating the scraped membrane; and immersing a resulting evaporated membrane scraped in a deionized water coagulation bath and curing to obtain the PVDF molecular sieve blend membrane; and
B. surface coating modifying the PVDF molecular sieve blend membrane: immersing the PVDF molecular sieve blend membrane in ethanol and deionized water in sequence each for 20 minutes to 40 minutes, and then immersing in a dopamine hydrochloride buffer solution with stirring under an ultrasonic environment for 16 hours to 24 hours to obtain the zeolite-like molecular sieve membrane for removing the fluorine and the chlorine from the waste acid.

In some embodiments, in step A, in the mixed solvent II, a mass percentage of the PVDF monomer particles is in a range of 6 wt % to 12 wt %, a mass percentage of the zeolite-like molecular sieve nanoparticles is in a range of 0.5 wt % to 2 wt %, a mass percentage of the VBC is 2 wt %, and a mass percentage of the BPO is 0.02 wt %.

In some embodiments, in step B, the dopamine hydrochloride buffer solution is prepared by a process consisting of: preparing tris(hydroxymethyl)aminomethane and hydrochloric acid into a buffer solution having a pH value of 8.5, and then dissolving DA (dopamine) and PEI (polyethylenimine) in the buffer solution to obtain the dopamine hydrochloride buffer solution.

In some embodiments, a mass percentage of the DA in the dopamine hydrochloride buffer solution is in a range of 0.2 wt % to 1.6 wt %.

In some embodiments, in step B, immersing the PVDF molecular sieve blend membrane in the dopamine hydrochloride buffer solution is carried out by conventional stirring under an ultrasonic environment for 16 hours to 24 hours.

### Example 1

S100: Under an ultrasonic environment, based on an equal mass per part, 6 parts of ZrCl₄ was dissolved in 44 parts of biphenyl-4,4′-dicarboxylic acid; and a resulting solution was dissolved in a second solvent consisting of 30 parts of deionized water, 10 parts of ethanol, and 10 parts of isohexanediol to obtain a mixed solution I (where a mass percentage of ZrCl₄ was 6 wt %); and the mixed solution I was dried to obtain zeolite-like molecular sieve nanoparticles.

S200: PVDF (polyvinylidene fluorine) monomer particles were dissolved in an organic solvent of DMF (N,N-dimethylformamide) having a mass concentration of 10%; the zeolite-like molecular sieve nanoparticles were added, and VBC (4-vinylbenzyl chloride) and BPO (benzoyl peroxide) to obtain a mixed solvent II, where a mass percentage of the PVDF monomer particles was 6%, a mass percentage of the zeolite-like molecular sieve nanoparticles was 0.5%, a mass percentage of VBC was 2%, and a mass percentage of BPO was 0.02%; the mixed solvent II was reacted at 65° C. for 8 hours under nitrogen protection to obtain a casting solution; the casting solution was vacuum degassed and stood for 8 hours; the casting solution was injected into a casting template and scraped into a scraped membrane with a scraper; the scraped membrane was evaporated to remove the organic solvent; and the scraped membrane was immersed in a deionized water coagulation bath and cured to obtain a PVDF molecular sieve blend membrane.

S300: Tris(hydroxymethyl)aminomethane and hydrochloric acid were prepared into a buffer solution having a pH value of 8.5, and then DA (dopamine) and PEI (polyethylenimine) were dissolved in the buffer solution to obtain a dopamine hydrochloride buffer solution having a mass concentration of 0.2%; the PVDF molecular sieve blend membrane was immersed in ethanol and deionized water in sequence each for 30 minutes, and then immersed in the dopamine hydrochloride buffer solution with stirring under an ultrasonic environment for 20 hours to obtain a dopamine-modified molecular sieve membrane, i.e., a zeolite-like molecular sieve membrane for removing fluorine and chlorine from waste acid.

In this example, the prepared zeolite-like molecular sieve membrane was subjected to experiments on fluorine and chlorine removal from waste acid. The purpose of the experiments is to study the volumes of the resulting desalinated water and concentrated water after fluorine and chlorine removal, as well as the concentrations of fluorine, chloride, and sulfate ions in the desalinated water and concentrated water, thereby determining the fluorine removal rate, chlorine removal rate, and retention rate of sulfate ions of the molecular sieve membrane.

Different batches of waste acid were sampled and tested before mixing for experiments on fluorine and chlorine removal from waste acid. The main indicators are shown in Table 1.

TABLE 1
Results of sampling and testing of different batches of waste acid

| Experimental group | F⁻ | Cl⁻ | SO₄²⁻ | SiO₂ | Fe | Cu | Cd |
|---|---|---|---|---|---|---|---|
| (waste acid) | (mg/L) | (mg/L) | (g/L) | (mg/L) | (mg/L) | (mg/L) | (mg/L) |
| 1 | 4250 | 6720 | 64.08 | 2049 | — | — | — |
| 2 | 3220 | 4620 | 49.54 | 1712 | — | — | — |
| 3 | 3530 | 5210 | 54.57 | 1947 | 2030 | 21.5 | 250.11 |
| 4 | 3870 | 5100 | 79.67 | 1886 | 2560 | — | — |
| 5 | 3610 | 4730 | 85.43 | 1486 | 1800 | 22.81 | 126.87 |
| 6 | 2500 | 5310 | — | — | — | — | — |
| 7 | 2740 | 5110 | 81.15 | 900.7 | 1270 | 43.22 | 60.58 |
| 8 | 2500 | 5030 | 82.38 | 859.2 | 1160 | 43.63 | 65.72 |
| Mean | 3277.5 | 5228.75 | 70.97 | 1548.56 | 1764 | 32.79 | 125.82 |

The mean values in a e were use as the final sampling data of waste acid. The bate of mixed waste acid was subjected to two consecutive experiments on fluorine and chlorine removal from waste acid by using the prepared zeolite-like molecular sieve membrane. The experimental results are shown in Table 2.

TABLE 2
Results I of two consecutive experiments on
fluorine and chlorine removal from waste acid

| | | F⁻ | Cl⁻ | SO₄²⁻ |
|---|---|---|---|---|
| | | (mg/L) | (mg/L) | (g/L) |
| Primary removal | 10 L of water inflow | 3277.5 | 5229 | 71 |
| of fluorine | 3 L of desalinated water | 7196.6 | 12659 | 28.4 |
| and chlorine | 7 L of concentrated | 1580 | 2045 | 89.26 |
| | water | | | |
| Secondary | 10 L of water inflow | 1580 | 2045 | 89.26 |
| removal | 3 L of desalinated water | 2140 | 5342 | 30.1 |
| of fluorine | 7 L of concentrated | 1340 | 632 | 114.67 |
| and chlorine | water | | | |

Primary removal of fluorine an chlorine: 10 L of mixed waste acid was subjected to removal by using the zeolite-like molecular sieve membrane, yielding a primary concentrated water and a primary desalinated water; secondary removal of fluorine and chlorine: 10 L of the resulting primary concentrated water was subjected to a secondary removal, yielding a secondary concentrated water and a secondary desalinated water.

After the data in Table 2 was processed, the fluorine removal rate in the primary removal of fluorine and chlorine reaches 65.87%, and the chlorine removal rate is 72.63%; the fluorine removal rate in the secondary removal of fluorine and chlorine reaches 40.63%, and the chlorine removal rate is 78.36%. After two removal processes, the fluorine removal rate of the combined primary and secondary processes reaches 79.96%, the chlorine removal rate reaches 94.08%, and the sulfate retention rate reaches 79.14%. In this example, the concentrated water is considered as fluorine- and chlorine-removed water, having a recovery rate of 49%; the desalinated water is high-fluorine-and-chlorine waste liquid used for other purposes.

### Example 2

S100: Under an ultrasonic environment, based on an equal mass per part, 5 parts of Zr(OH)₄ was dissolved in 40 parts of trimesic acid; and a resulting solution was dissolved in a second solvent consisting of 25 parts of deionized water, 15 parts of ethanol, 10 parts of isopentyldiol, and 5 parts of isohexanediol to obtain a mixed solution I (where a mass percentage of Zr(OH)₄ was 5 wt %); and the mixed solution I was dried to obtain zeolite-like molecular sieve nanoparticles.

S200: The procedures were the same as step S200 in Example 1 except that the PVDF monomer particles were dissolved in an organic solvent of DMF having a mass concentration of 8%, a mass percentage of PVDF in the mixed solvent II was 12%, and a mass percentage of the zeolite-like nanoparticles was 2%; the mixed solvent II was reacted at 70° C. for 7 hours under nitrogen protection to obtain a casting solution; the casting solution was vacuum degassed and stood for 9 hours.

S300: The procedures were the same as step S300 in Example 1 except that a dopamine hydrochloride buffer solution having a mass concentration of 1.6% was prepared, and the PVDF molecular sieve blend membrane was immersed in ethanol and deionized water in sequence each for 20 minutes, and then immersed in the dopamine hydrochloride buffer solution with stirring under an ultrasonic environment for 24 hours, to obtain a zeolite-like molecular sieve membrane for removing fluorine and chlorine from waste acid.

The mixed waste acid treated in this example is the same as that in Example 1. Two consecutive experiments on fluorine and chlorine removal from waste acid were conducted by using the prepared zeolite-like molecular sieve membrane. The experimental results are shown in Table 3.

TABLE 3
Results II of two consecutive experiments on
fluorine and chlorine removal from waste acid

| | | F⁻ | Cl⁻ | SO₄²⁻ |
|---|---|---|---|---|
| | | (mg/L) | (mg/L) | (g/L) |
| Primary removal | 10 L of water inflow | 3277.5 | 5229 | 71 |
| of fluorine | 2.75 L of desalinated | 5201.09 | 12041.91 | 27.73 |
| and chlorine | water | | | |
| | 7.25 L of concentrated | 2547.86 | 2644.79 | 87.41 |
| | water | | | |
| Secondary | 10 L of water inflow | 2547.86 | 2644.79 | 87.41 |
| removal | 2.75 L of desalinated | 3378.93 | 6282.103 | 40.11 |
| of fluorine | water | | | |
| and chlorine | 7.25 L of concentrated | 2232.63 | 1265.123 | 105.35 |
| | water | | | |

After the data in Table 3 was processed, the fluorine removal rate in the primary removal of fluorine and chlorine reaches 43.64%, and the chlorine removal rate is 63.33%; the fluorine removal rate in the secondary removal of fluorine and chlorine reaches 36.47%, and the chlorine removal rate is 65.32%; after two removal processes, the fluorine removal rate of the combined primary and secondary processes reaches 58.46%, the chlorine removal rate reaches 85.24%, and the sulfate retention rate reaches 90.95%. In this example, the concentrated water is considered as fluorine- and chlorine-removed water, having a recovery rate of 52.57%.

### Example 3

S100: Under an ultrasonic environment, based on an equal mass per part, 14 parts of ZrSO₄ was dissolved in 30 parts of dimethylimidazole; and a resulting solution was dissolved in a second solvent consisting of 50 parts of deionized water and 6 parts of ethanol to obtain a mixed solution I (where a mass percentage of ZrSO₄ was 14 wt %); and the mixed solution I was dried to obtain zeolite-like molecular sieve nanoparticles.

S200: The procedures were the same as step S200 in Example 1 except that the PVDF monomer particles were dissolved in an organic solvent of DMF having a mass concentration of 12%, a mass percentage of PVDF in the mixed solvent II was 8%, and a mass percentage of the zeolite-like nanoparticles was 1%; the mixed solvent II was reacted at 60° C. for 8 hours under nitrogen protection to obtain a casting solution; the casting solution was vacuum degassed and stood for 8 hours.

S300: The procedures were the same as step S300 in Example 1 except that a dopamine hydrochloride buffer solution having a mass concentration of 1.0% was prepared, and the PVDF molecular sieve blend membrane was immersed in ethanol and deionized water in sequence each for 40 minutes, and then immersed in the dopamine hydrochloride buffer solution with stirring under an ultrasonic environment for 16 hours, to obtain a zeolite-like molecular sieve membrane for removing fluorine and chlorine from waste acid.

The mixed waste acid treated in this example is the same as that in Example 1. Two consecutive experiments on fluorine and chlorine removal from waste acid were conducted by using the prepared zeolite-like molecular sieve membrane. The experimental results are shown in Table 4.

TABLE 4
Results III of two consecutive experiments on
fluorine and chlorine removal from waste acid

| | | F⁻ | Cl⁻ | SO₄²⁻ |
|---|---|---|---|---|
| | | (mg/L) | (mg/L) | (g/L) |
| Primary | 10 L of water inflow | 3277.5 | 5229 | 71 |
| removal | 2.68 L of desalinated | 6711.54 | 13778.81 | 28.45 |
| of fluorine | water | | | |
| and chlorine | 7.32 L of concentrated | 2020.23 | 2098.74 | 86.58 |
| | water | | | |
| Secondary | 10 L of water inflow | 2020.23 | 2098.74 | 86.58 |
| removal | 2.74 L of desalinated | 3793.46 | 5233.071 | 39.88 |
| of fluorine | water | | | |
| and chlorine | 7.26 L of concentrated | 1350.99 | 915.8153 | 104.20 |
| | water | | | |

After the data in Table 4 was processed, the fluorine removal rate in the primary removal of fluorine and chlorine reaches 54.88%, and the chlorine removal rate is 70.62%; the fluorine removal rate in the secondary removal of fluorine and chlorine reaches 51.45%, and the chlorine removal rate is 68.32%; after two removal processes, the fluorine removal rate of the combined primary and secondary processes reaches 78.09%, the chlorine removal rate reaches 90.69%, and the sulfate retention rate reaches 78%. In this example, the concentrated water is considered as fluorine- and chlorine-removed water, having a recovery rate of 53.15%.

### Example 4

S100: Under an ultrasonic environment, based on an equal mass per part, 4 parts of CuSO₄ was dissolved in 35 parts of imidazole; and a resulting solution was dissolved in a second solvent consisting of 25 parts of deionized water, 15 parts of ethanol, 11 parts of isopentyldiol and 10 parts of isohexanediol to obtain a mixed solution I (where a percentage of CuSO₄ was 4 wt %); and the mixed solution I was dried to obtain zeolite-like molecular sieve nanoparticles.

S200: The procedures were the same as step S200 in Example 1 except that a mass percentage of PVDF in the mixed solvent II was 6%, and a mass percentage of zeolite-like nanoparticles was 2%; the mixed solvent II was reacted at 60° C. for 8 hours under nitrogen protection to obtain a casting solution; the casting solution was vacuum degassed and stood for 9 hours.

S300: The procedures were the same as step S300 in Example 1 except that a dopamine hydrochloride buffer solution having a mass concentration of 1.2% was prepared, and the PVDF molecular sieve blend membrane was immersed in ethanol for 20 minutes and then deionized water for 40 minutes, and then immersed in the dopamine hydrochloride buffer solution with stirring under an ultrasonic environment for 22 hours, to obtain a zeolite-like molecular sieve membrane for removing fluorine and chlorine from waste acid.

The mixed waste acid treated in this example is the same as that in Example 1. Two consecutive experiments on fluorine and chlorine removal from waste acid were conducted by using the prepared zeolite-like molecular sieve membrane. The experimental results are shown in Table 5.

TABLE 5
Results IV of two consecutive experiments on
fluorine and chlorine removal from waste acid

| | | F⁻ | Cl⁻ | SO₄²⁻ |
|---|---|---|---|---|
| | | (mg/L) | (mg/L) | (g/L) |
| Primary removal | 10 L of water inflow | 3277.5 | 5229 | 71 |
| of fluorine | 3.32 L of desalinated | 5643.82 | 11250.23 | 36.91 |
| and chlorine | water | | | |
| | 6.68 L of concentrated | 2101.43 | 2236.42 | 87.94 |
| | water | | | |
| Secondary | 10 L of water inflow | 2101.43 | 2236.42 | 87.94 |
| removal | 3.25 L of desalinated | 3468.32 | 4644.174 | 45.27 |
| of fluorine | water | | | |
| and chlorine | 6.75 L of concentrated | 1443.29 | 1077.124 | 108.49 |
| | water | | | |

After the data in Table 5 was processed, the fluorine removal rate in the primary removal of fluorine and chlorine reaches 57.17%, and the chlorine removal rate is 71.43%; the fluorine removal rate in the secondary removal of fluorine and chlorine reaches 53.64%, and the chlorine removal rate is 67.49%; after two removal processes, the fluorine removal rate of the combined primary and secondary processes reaches 80.14%, the chlorine removal rate reaches 92.88%, and the sulfate retention rate reaches 68.90%. In this example, the concentrated water is considered as fluorine- and chlorine-removed water, having a recovery rate of 45.09%.

### Example 5

S100: Under an ultrasonic environment, based on an equal mass per part, 8 parts of Cr₂(SO₄)₃ was dissolved in 51 parts of succinic acid; and a resulting solution was dissolved in a second solvent consisting of 30 parts of deionized water and 11 parts of ethanol to obtain a mixed solution I (where a mass percentage of Cr₂(SO₄)₃ was 8 wt %); and the mixed solution I was dried to obtain zeolite-like molecular sieve nanoparticles.

S200: The procedures were the same as step S200 in Example 1 except that a mass percentage of PVDF in the mixed solvent II was 12%, and a mass percentage of zeolite-like nanoparticles was 0.5%; the mixed solvent II was reacted at 70° C. for 6 hours under nitrogen protection to obtain a casting solution; the casting solution was vacuum degassed and stood for 8 hours.

S300: The procedures were the same as step S300 in Example 1 except that a dopamine hydrochloride buffer solution having a mass concentration of 0.8% was prepared, and the PVDF molecular sieve blend membrane was immersed in ethanol for 30 minutes and then deionized water for 20 minutes, and then immersed in the dopamine hydrochloride buffer solution with stirring under an ultrasonic environment for 19 hours, to obtain a zeolite-like molecular sieve membrane for removing fluorine and chlorine from waste acid.

The mixed waste acid treated in this example is the same as that in Example 1. Two consecutive experiments on fluorine and chlorine removal from waste acid were conducted by using the prepared zeolite-like molecular sieve membrane. The experimental results are shown in Table 6.

TABLE 6
Results V of two consecutive experiments on
fluorine and chlorine removal from waste acid

| | | F⁻ | Cl⁻ | SO₄²⁻ |
|---|---|---|---|---|
| | | (mg/L) | (mg/L) | (g/L) |
| Primary removal | 10 L of water inflow | 3277.5 | 5229 | 71 |
| of fluorine | 2.81 L of desalinated | 7043.71 | 12735.69 | 39.80 |
| and chlorine | water | | | |
| | 7.19 L of concentrated | 1805.59 | 2295.23 | 83.20 |
| | water | | | |
| Secondary | 10 L of water inflow | 1805.59 | 2295.23 | 83.20 |
| removal | 2.8 L of desalinated | 3435.13 | 5095.417 | 48.05 |
| of fluorine | water | | | |
| and chlorine | 7.2 L of concentrated | 1171.88 | 1206.272 | 96.86 |
| | water | | | |

After the data in Table 6 was processed, the fluorine removal rate in the primary removal of fluorine and chlorine reaches 60.39%, and the chlorine removal rate is 68.44%; the fluorine removal rate in the secondary removal of fluorine and chlorine reaches 53.27%, and the chlorine removal rate is 62.16%; after two removal processes, the fluorine removal rate of the combined primary and secondary processes reaches 81.45%, the chlorine removal rate reaches 88.06%, and the sulfate retention rate reaches 70.62%. In this example, the concentrated water is considered as fluorine- and chlorine-removed water, having a recovery rate of 51.77%.

### Comparative Example 1

The experimental steps were exactly the same as in Example 1, and the batches of waste acid to be treated were the same, except that step S300 was not performed. The effects of surface coating modification of the blend membrane on the removal rates of fluoride and chlorine and the sulfate retention rate of the prepared molecular sieve membrane were studied. The experimental results are shown in Table 7.

TABLE 7
Experimental results of fluorine and chlorine removal
from waste acid in Comparative Example 1

| | | F⁻ | Cl⁻ | SO₄²⁻ |
|---|---|---|---|---|
| | | (mg/L) | (mg/L) | (g/L) |
| Blend membrane | 20 L of water inflow | 230.24 | 117.28 | 353.66 |
| without coating | 4.87 L of desalinated | 592.19 | 340.33 | 164.71 |
| modification | water | | | |
| | 15.13 L of concentrated | 113.65 | 45.56 | 414.48 |
| | water | | | |

After the data in Table 7 was processed, it can be seen that the molecular sieve membrane obtained without coating modification of the blend membrane has a fluorine removal rate of 62.63%, a chlorine removal rate of 70.66%, and a sulfate retention rate of 88.66%. In this comparative example, the concentrated water is permeate water, and the permeate flux through the membrane reaches 24.35%.

In Example 1, the zeolite-like molecular sieve membrane achieves a comprehensive fluorine removal rate of 79.96%, a chlorine removal rate of 94.08%, a sulfate retention rate of 79.14%, and a recovery rate of fluorine- and chlorine-removed water up to 49%.

Comparing Example 1 with Comparative Example 1, it can be concluded that coating modification of the blend membrane can improve the removal rates of fluoride and chloride ions, and significantly increase the recovery rate of fluorine- and chlorine-removed water, rendering the PVDF molecular sieve blend membrane corrosion resistant while reducing the hydrophobicity and increasing the permeate flux.

### Comparative Example 2

Same as the batches of waste acid treated in Example 1, this comparative example used a PVDF flat sheet ultrafiltration membrane to conduct experiments on fluorine and chlorine removal from the waste acid. The purpose of the experiments is to study the concentrations of fluorine and chlorine ions and sulfate ions in the desalinated water and concentrated water after fluorine and chlorine removal, and further to obtain the fluorine removal rate, chlorine removal rate and sulfate retention rate of the ultrafiltration membrane, for comparison with those of Example 1. The experimental results are shown in Table 8.

TABLE 8
Experimental results of fluorine and chlorine removal
from waste acid in Comparative Example 2

| | F⁻ | Cl⁻ | SO₄²⁻ | SiO₂ | Fe | Cu | Cd |
|---|---|---|---|---|---|---|---|
| | (mg/L) | (mg/L) | (g/L) | (mg/L) | (mg/L) | (mg/L) | (mg/L) |
| Ultrafiltration feed | 3610 | 4730 | 85.43 | 1486 | 1800 | 22.81 | 126.87 |
| Ultrafiltration | 3595 | 4722 | 85.44 | 1325 | 1768 | 22.24 | 122.93 |
| permeate | | | | | | | |

After the data in Table 8 was processed, it can be seen that the ultrafiltration membrane has a fluorine removal rate of 0.4%, a chlorine removal rate of 0.2%, and a sulfate retention rate of 0%.

Conclusion: The ultrafiltration membrane is not suitable for removing fluorine and chloride ions from waste acid or for retaining sulfate ions.

### Comparative Example 3

Same as the batches of waste acid treated in Example 1, this comparative example used a completely unmodified conventional nanofiltration membrane to conduct experiments on fluorine and chlorine removal from the waste acid. The purpose of the experiments is to study the concentrations of fluorine and chlorine ions and sulfate ions in the desalinated water and concentrated water after fluorine and chlorine removal, and further to obtain the fluorine removal rate, chlorine removal rate and sulfate retention rate of the conventional nanofiltration membrane, for comparison with those of Example 1. The experimental results are shown in Table 9.

TABLE 9
Experimental results of fluorine and chlorine removal
from waste acid in Comparative Example 3

| Item | Feed | Permeate |
|---|---|---|
| F⁻ (mg/L) | 1.72 | 0.11 |
| Cl⁻ (mg/L) | 1310.66 | 237.65 |
| SO₄²⁻ (mg/L) | 2541.75 | 38.13 |

After the data in Table 9 was processed, it can be seen that the conventional nanofiltration membrane has a fluorine removal rate of 3.19%, a chlorine removal rate of 9.07%, and a sulfate retention rate of 99.25%.

Conclusion: Compared with Example 1, the conventional nanofiltration membrane has lower removal rates of fluorine and chloride ions, and fluorine and chloride ions and sulfate ions are all difficult to separate from the pores of the conventional nanofiltration membrane.

The foregoing descriptions are no more than preferably specific embodiments of the present disclosure, but the scope of the present disclosure is not limited thereto. Any variation or replacement readily conceived by a person skilled in the art within the scope of the present disclosure contained in the present disclosure shall be included within the scope of the present disclosure. Therefore, the scope of the present disclosure shall be subject to the protection scope of the claims.

What is claimed is:

1. A zeolite-like molecular sieve membrane for removing fluorine and chlorine from a waste acid, comprising a dispersed phase and a continuous phase, wherein
the dispersed phase is zeolite-like molecular sieve nanoparticles, and the continuous phase is formed by dissolving PVDF particles;
the zeolite-like molecular sieve nanoparticles are prepared by, under an ultrasonic environment, dissolving a metal compound in a first solvent, then dissolving in a second solvent to form a mixed solution, and finally drying the mixed solution;
a mass percentage of the metal compound in the mixed solution is in a range of 2 wt % to 20 wt %; and
the zeolite-like molecular sieve nanoparticles have a cage-like spatial structure, and voids formed between cages become channels for ions passing through and having a pore size of 1 nm to 6 nm.

2. The zeolite-like molecular sieve membrane for removing the fluorine and the chlorine from the waste acid of claim 1, wherein the metal compound is selected from the group consisting of ZrCl₄ and Zr(OH)₄, the first solvent is selected from the group consisting of trimesic acid and biphenyl-4,4′-dicarboxylic acid, and the second solvent is a solution of one or any combination of ethanol, isopentyldiol, and isohexanediol in deionized water.

3. The zeolite-like molecular sieve membrane for removing the fluorine and the chlorine from the waste acid of claim 1, wherein the metal compound is any one selected from the group consisting of ZnSO₄, ZnCl₂, CoCl₂, Co(NO₃)₂, CuSO₄, and Cu(NO₃)₂, the first solvent is one or any combination selected from the group consisting of imidazole, dimethylimidazole, and 2-methylimidazole, and the second solvent is a solution of one or any combination of ethanol, isopentyldiol, and isohexanediol in deionized water.

4. The zeolite-like molecular sieve membrane for removing the fluorine and the chlorine from the waste acid of claim 1, wherein the metal compound is selected from the group consisting of ZrCl₄, Zr(OH)₄, and Cr₂(SO₄)₃, the first solvent is succinic acid, and the second solvent is a solution of one or any combination of ethanol, isopentyldiol, and isohexanediol in deionized water.

5. A method for preparing a zeolite-like molecular sieve membrane for removing fluorine and chlorine from a waste acid, comprising steps of preparing a PVDF molecular sieve blend membrane by blending and surface coating modifying the PVDF molecular sieve blend membrane, specifically:
A. preparing the PVDF molecular sieve blend membrane by blending: dissolving PVDF particles in an organic solvent DMF with a concentration of 8 wt % to 12 wt %, adding the zeolite-like molecular sieve nanoparticles of the zeolite-like molecular sieve membrane for removing the fluorine and the chlorine from the waste acid of claim 1, and then adding monomer polymerization initiators VBC and BPO, to obtain a mixed solvent II; subsequently, reacting the mixed solvent II at a temperature of 60° C. to 70° C. for 7 hours to 9 hours under nitrogen protection to obtain a casting solution; next, vacuum degassing the casting solution and standing for 7 hours to 9 hours; then injecting the casting solution into a casting template and scraping into a membrane with a scraper; removing the organic solvent by evaporating a resulting scraped membrane; finally, immersing the resulting scraped membrane in a deionized water coagulation bath and curing to obtain the PVDF molecular sieve blend membrane; and
B. surface coating modifying the PVDF molecular sieve blend membrane: immersing the PVDF molecular sieve blend membrane in ethanol and deionized water in sequence each for 20 minutes to 40 minutes, and then immersing in a dopamine hydrochloride buffer solution with stirring under an ultrasonic environment for 16 hours to 24 hours to obtain the zeolite-like molecular sieve membrane for removing the fluorine and the chlorine from the waste acid.

6. The method for preparing the zeolite-like molecular sieve membrane for removing the fluorine and the chlorine from the waste acid of claim 5, wherein
in step A, in the mixed solvent II, a mass percentage of PVDF is in a range of 6 wt % to 12 wt %, a mass percentage of the zeolite-like molecular sieve nanoparticles is in a range of 0.5 wt % to 2 wt %, a mass percentage of the VBC is 2 wt %, and a mass percentage of the BPO is 0.02 wt %.

7. The method for preparing the zeolite-like molecular sieve membrane for removing the fluorine and the chlorine from the waste acid of claim 5, wherein
in step B, the dopamine hydrochloride buffer solution is prepared by a process consisting of: preparing tris(hydroxymethyl)aminomethane and hydrochloric acid into a buffer solution having a pH of 8.5, and dissolving DA and PEI in the buffer solution to obtain the dopamine hydrochloride buffer solution.

8. The method for preparing the zeolite-like molecular sieve membrane for removing the fluorine and the chlorine from the waste acid of claim 7, wherein a mass percentage of the DA in the dopamine hydrochloride buffer solution is in a range of 0.2 wt % to 1.6 wt %.

9. The method for preparing the zeolite-like molecular sieve membrane for removing the fluorine and the chlorine from the waste acid of claim 5, wherein the metal compound is selected from the group consisting of ZrCl₄ and Zr(OH)₄, the first solvent is selected from the group consisting of trimesic acid and biphenyl-4,4′-dicarboxylic acid, and the second solvent is a solution of one or any combination of ethanol, isopentyldiol, and isohexanediol in deionized water.

10. The method for preparing the zeolite-like molecular sieve membrane for removing the fluorine and the chlorine from the waste acid of claim 5, wherein the metal compound is any one selected from the group consisting of ZnSO₄, ZnCl₂, CoCl₂, Co(NO₃)₂, CuSO₄, and Cu(NO₃)₂, the first solvent is one or any combination selected from the group consisting of imidazole, dimethylimidazole, and 2-methylimidazole, and the second solvent is a solution of one or any combination of ethanol, isopentyldiol, and isohexanediol in deionized water.

11. The method for preparing the zeolite-like molecular sieve membrane for removing the fluorine and the chlorine from the waste acid of claim 5, wherein the metal compound is selected from the group consisting of ZrCl₄, Zr(OH)₄, and Cr₂(SO₄)₃, the first solvent is succinic acid, and the second solvent is a solution of one or any combination of ethanol, isopentyldiol, and isohexanediol in deionized water.
